(19) United States
(12) Patent Application Publication
(10) Pub. No.: US 2011/0228100 A1
(43) Pub. Date: Sep. 22, 2011

(54) OBJECT TRACKING DEVICE AND METHOD OF CONTROLLING OPERATION OF THE SAME

(75) Inventors: Koichi YAHAGI, Saitama-shi (JP); Yitong ZHANG, Saitama-shi (JP); Tetsu WADA, Saitama-shi (JP); Koichi TANAKA, Saitama-shi (JP)

(73) Assignee: FUJIFILM CORPORATION, Tokyo (JP)

(21) Appl. No.: 13/040,051

(22) Filed: Mar. 3, 2011

(30) Foreign Application Priority Data
Mar. 18, 2010 (JP) P2010-063275

(51) Int. Cl. H04N 5/225

(52) U.S. Cl. 348/169; 348/E05.024

(57) ABSTRACT

Disclosed is a technique for accurately tracking a tracking target object. A disparity map image in which the disparity of each pixel of an object is shown is generated from a three-dimensional object image. A detection range is determined such that an object disposed on the front side of a pedestrian, which is a tracking target object, in the depth direction is excluded from the generated disparity map image. The pedestrian, which is a tracking target object, is detected in the determined detection range. In this way, it is possible to prevent a bike driver disposed on the front side of the pedestrian in the depth direction from being tracked.

### BACKGROUND OF THE INVENTION

1. Field of the Invention

The present invention relates to an object tracking device and a method of controlling the operation of the same.

2. Description of the Related Art

Some camera, video camera, scope such as telescope and telescope type optical sights or the like has a function to measure a distance to an object. For example, the following digital cameras represented by digital still cameras have been proposed: a digital still camera that uses its function to measure the distance using triangulation and is focused on an object (JP2001-235675A); and a digital still camera that performs a focus operation using a distance measuring unit (JP2008-175922A). In addition, a digital camera or the like has been proposed which has a tracking function of continuously capturing the image of an object and displaying the object such that, for example, a specific person or a face is put into a frame. For example, the digital camera with the tracking function needs to accurately track an object. In order to carry out the tracking with high accuracy, it is necessary to consider the problem of the occlusion region, i.e. the region that cannot be detected by the overlapping of the several subjects. To understand the state of the occlusion region, it is desirable to obtain the distant information to the subject in time-series. If the precise distance information of the subject in time-series can be obtained, the position relationship among subjects in the depth direction can be obtained and thereby occlusion region can be detected precisely. In the conventional art, to detect the occlusion region precisely, the change of the distance to the subject in time-series was measured by carrying out autofocus operation repetitively. Alternatively, to detect the occlusion region precisely, the change of the distance to the subject in time-series was measured in high-speed by using expensive high speed distance measurement sensor.

### SUMMARY OF THE INVENTION

However, repetitive autofocus operation may cause a problem of time consuming due to the driving of the focus lens and the shortening of lens life due to the repetitive driving of the focus lens. Moreover, since the high speed distance measurement sensor is expensive, there is a problem that machinery comprising such expensive sensor may become expensive in total.

Therefore, the invention has been made in view of the above-mentioned problems and an object of the invention is to provide a tracking device capable of reducing the price of a machinery comprising the tracking device, and capable of obtaining a distance information to the subject while extending lens life.

In order to achieve the object, according to a first aspect of the invention, there is provided an object tracking device to which first object image data indicating a first object image captured by a photographing unit and second object image data that has a disparity with respect to the first object image and indicates a second object image captured by a photographing unit at the same time as the first object image is captured are continuously input. The object tracking device includes: a tracking target determining unit that determines a tracking target object; a disparity map generating unit that generates a disparity map indicating the disparity between portions of the first object image and the second object image respectively indicated by the first object image data and the second object image data which are obtained by image capture at the same time and are continuously input; a detection target range determining unit that determines a portion other than an object which is disposed between the photographing unit and the tracking target object determined by the tracking target determining unit in the depth direction to be a detection target range of the tracking target, on the basis of the disparity map generated by the disparity map generating unit; and a tracking object image detecting unit that detects an object image indicating the tracking target object from at least one of the first object image and the second object image in the detection target range determined by the detection target range determining unit.

The first aspect of the invention also provides an operation control method suitable for the object tracking device. That is, there is provided a method of controlling the operation of an object tracking device to which first object image data indicating a first object image and second object image data that has a disparity with respect to the first object image and indicates a second object image captured at the same time as the first object image is captured are continuously input. The method includes: allowing a tracking target determining unit to determine a tracking target object; allowing a disparity map generating unit to generate a disparity map indicating the disparity between portions of the first object image and the second object image respectively indicated by the first object image data and the second object image data which are obtained by image capture at the same time and are continuously input; allowing a detection target range determining unit to determine a portion other than an object which is disposed between the photographing unit and the tracking target object i.e. disposed on the front side of the tracking target, the tracking object being determined by the tracking target determining unit in the depth direction to be a detection target range of the tracking target, on the basis of the disparity map generated by the disparity map generating unit; and allowing a tracking object image detecting unit to detect an object image indicating the tracking target object from at least one of the first object image and the second object image in the detection target range determined by the detection target range determining unit.

According to the first aspect of the invention, the first object image data indicating the first object image and the second object image data that has a disparity with respect to the first object image and indicates the second object image captured at the same time as the first object image is captured are continuously input. The disparity map indicating the disparity between portions of the first object image and the second object image that are captured at the same time is generated. A portion other than the object disposed between the photographing unit and the tracking target object in the depth direction is determined to be the detection target range of the tracking target in the generated disparity map. The object image indicating the tracking target object is detected from at least one of the first object image and the second object image in the determined detection target range.

According to the first aspect of the invention, the disparity map is generated. The disparity map substantially indicates the distance to the object in the imaging range. A portion other than the object disposed between the photographing unit and the tracking target object in the depth direction is determined to be the detection target range of the tracking target in the generated disparity map, and the tracking target object is detected from the detection target range. The object disposed between the photographing unit and the tracking target object in the depth direction is excluded from the detection target range for detecting the tracking target object. Therefore, even when there is an obstacle between a tracking target and the first and second imaging devices, it is possible to relatively accurately track the tracking target. Moreover, there are no concerns for the time consuming due to the driving of the focus lens and deterioration of the focus lens due to the repetitive driving of the focus lens. Moreover, the cost of the machinery can be reduced since the expensive high speed distance measurement sensor is not required any more.

The detection target range determining unit may determine a portion other than an image portion with a disparity less than that of an image portion corresponding to the tracking target object to be the tracking target detection range, on the basis of the disparity map generated by the disparity map generating unit.

The detection target range determining unit may determine an image portion with a disparity within a predetermined disparity range of an image portion corresponding to the tracking target object to be the tracking target detection range, on the basis of the disparity map generated by the disparity map generating unit. According to the above-mentioned structure, since the tracking target detection range is limited, it is possible to reduce the time required for tracking.

According to a second aspect of the invention, there is provided an object tracking device to which first object image data indicating a first object image and second object image data that has a disparity with respect to the first object image and indicates a second object image captured at the same time as the first object image is captured are continuously input. The object tracking device includes: a tracking target determining unit that determines a tracking target object; a disparity map image generating unit that generates a disparity map image whose brightness or grayscale varies depending on the disparity between portions of the first object image and the second object image respectively indicated by the first object image data and the second object image data which are obtained by image capture at the same time and are continuously input; a template image extracting unit that extracts an image portion corresponding to the tracking target object determined by the tracking target determining unit as a template image in the disparity map image generated by the disparity map image generating unit; and a tracking object image detecting unit that detects the same image portion as the template image extracted by the template image extracting unit from a disparity map image which is generated by the disparity map image generating unit after the disparity map image from which the template image is extracted by the template image extracting unit.

The second aspect of the invention also provides an operation control method suitable for the object tracking device. That is, there is provided a method of controlling the operation of an object tracking device to which first object image data indicating a first object image and second object image data that has a disparity with respect to the first object image and indicates a second object image captured at the same time as the first object image is captured are continuously input. The method includes: allowing a tracking target determining unit to determine a tracking target object; allowing a disparity map image generating unit to generate a disparity map image whose brightness or grayscale varies depending on the disparity between portions of the first object image and the second object image respectively indicated by the first object image data and the second object image data which are obtained by image capture at the same time and are continuously input; allowing a template image extracting unit to extract an image portion corresponding to the tracking target object as a template image in the disparity map image generated by the disparity map image generating unit; and allowing a tracking object image detecting unit to detect the same image portion as the template image extracted by the template image extracting unit from a disparity map image which is generated by the disparity map image generating unit after the disparity map image from which the template image is extracted by the template image extracting unit.

According to the second aspect of the invention, the disparity map image whose brightness varies depending on the disparity between portions of the first object image and the second object image that are captured at the same time is generated. An image portion corresponding to the tracking target object is extracted as a template image from the disparity map image. The same image portion as the extracted template image is detected from the disparity map image generated after the disparity map image from which the template image is extracted.

An image portion corresponding to the tracking target object is detected from the disparity map image. Therefore, when a low-contrast image is used to track an object, it may be difficult to perform tracking. According to the second aspect of the invention, the disparity map image is used to perform tracking. Therefore, even when a low-contrast image is captured, it is possible to track an object.

According to a third aspect of the invention, there is provided an object tracking device to which first object image data indicating a first object image and second object image data that has a disparity with respect to the first object image and indicates a second object image captured at the same time as the first object image is captured are continuously input. The object tracking device includes: a disparity map generating unit that generates a disparity map indicating the disparity between portions of the first object image and the second object image respectively indicated by the first object image data and the second object image data which are obtained by image capture at the same time and are continuously input; a differential disparity map generating unit that generates a differential disparity map indicating a difference between the disparities of two disparity maps generated by the disparity map generating unit; and a tracking object image detecting unit that detects an object image indicating the tracking target object from the first object image or the second object image corresponding to a portion with a disparity difference equal to or more than a predetermined value in the differential disparity map generated by the differential disparity map generating unit.

The third aspect of the invention also provides an operation control method suitable for the object tracking device. That is, there is provided a method of controlling the operation of an object tracking device to which first object image data indicating a first object image and second object image data that has a disparity with respect to the first object image and indicates a second object image captured at the same time as the first object image is captured are continuously input. The method includes: allowing a tracking target determining unit to determine a tracking target object; allowing a disparity map generating unit to generate a disparity map indicating the disparity between portions of the first object image and the second object image respectively indicated by the first object image data and the second object image data which are obtained by image capture at the same time and are continuously input; allowing a differential disparity map generating unit to generate a differential disparity map indicating a difference between the disparities of two disparity maps generated by the disparity map generating unit; and allowing a tracking object image detecting unit to detect an object image indicating the tracking target object determined by the tracking target determining unit from the first object image or the second object image corresponding to a portion with a disparity difference equal to or more than a predetermined value in the differential disparity map generated by the differential disparity map generating unit.

According to the third aspect of the invention, the differential disparity map indicating the difference between the disparities of two disparity maps generated by the disparity map generating unit is generated. The object image indicating the tracking target object is detected from the first object image or the second object image corresponding to a portion with a disparity difference equal to or more than a predetermined value in the generated differential disparity map.

According to the third aspect of the invention, an imaging portion with a disparity difference equal to or more than a predetermined value indicates a moving object. Since it is generally considered that a tracking target is a moving object, it is possible to detect the tracking target from the moving object.

### BRIEF DESCRIPTION OF THE DRAWINGS

FIGS. 1A and 1B are block diagrams illustrating the electrical structure of a digital still camera;

FIG. 2 is a diagram illustrating an example of an image for the left eye;

FIG. 3 is a diagram illustrating an example of an image for the right eye;

FIG. 4 is a diagram illustrating an example of a disparity map image;

FIG. 5 is a diagram illustrating the relationship among a disparity, the image for the right eye, and the image for the left eye;

FIGS. 6A to 6D are diagrams illustrating an example of an object image.

FIGS. 7A to 7D are diagrams illustrating an example of the disparity map image;

FIGS. 8A to 8D are diagrams illustrating an example of the object image;

FIGS. 9A to 9D are diagrams illustrating an example of the object image;

FIG. 10 is a diagram illustrating an example of the disparity map image;

FIG. 11 is a diagram illustrating the disparity map image and a differential disparity map image;

FIG. 12 is a flowchart illustrating an auto-tracking process;

FIG. 13 is a flowchart illustrating the auto-tracking process;

FIG. 14 is a flowchart illustrating the auto-tracking process; and

FIG. 15 is a flowchart illustrating the auto-tracking process.

### DESCRIPTION OF THE PREFERRED EMBODIMENTS

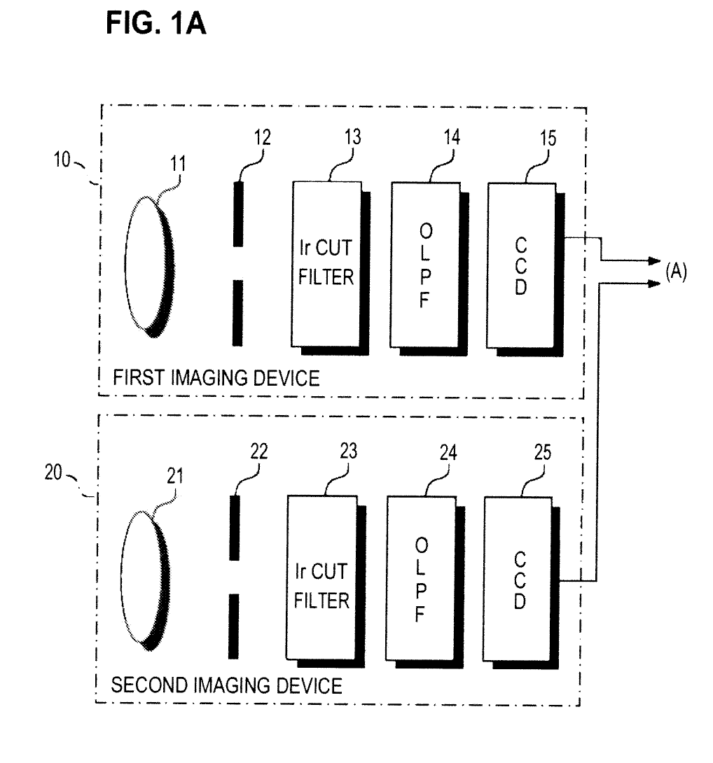

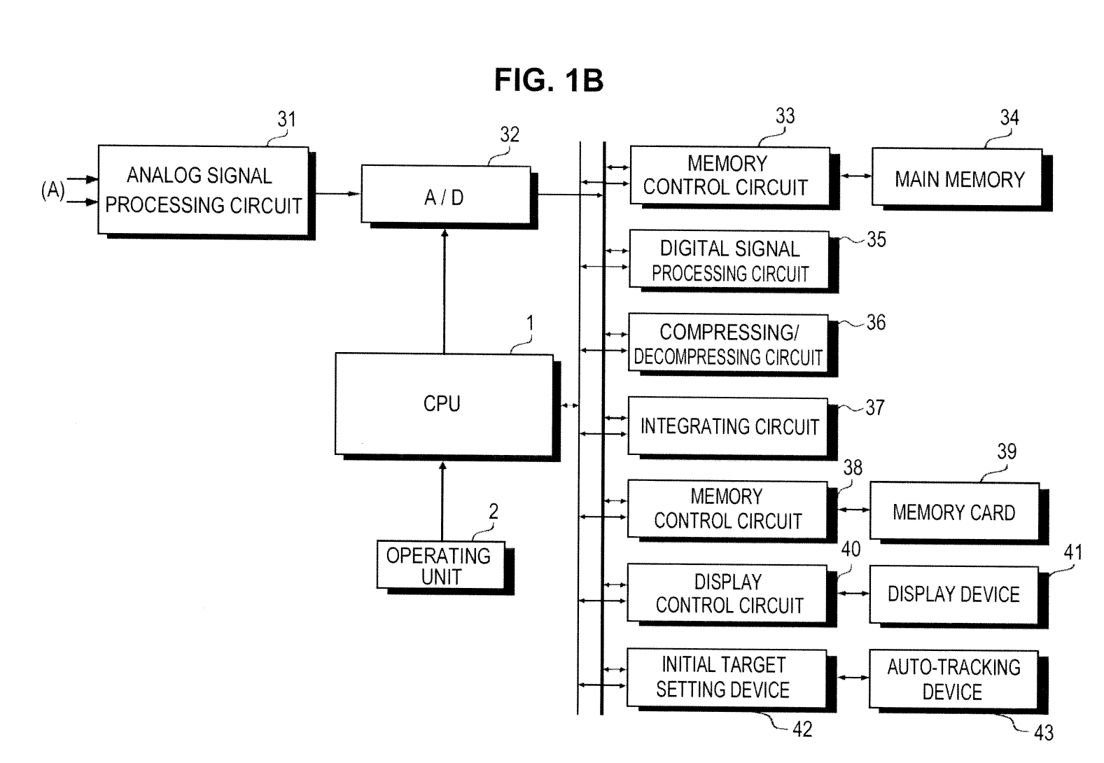

FIGS. 1A and 1B are block diagrams illustrating the electrical structure of a digital still camera according to an embodiment of the invention. The embodiment of the invention is not limited to the digital still camera, but may also be applied to a digital movie video camera.

The overall operation of the digital still camera is controlled by a CPU 1.

The digital still camera includes an operating unit 2. The operating unit 2 includes, for example, a power button, a mode setting dial, and a two-stage-stroke-type shutter release button. An operation signal output from the operating unit 2 is input to the CPU 1. The modes set by the mode setting dial include, for example, the imaging mode and the reproduction mode.

The digital still camera according to this embodiment may capture a three-dimensional object image. In order to capture the three-dimensional object image, the digital still camera includes a first imaging device 10 that captures an object image for the right eye seen by the right eye of the viewer and a second imaging device 20 that captures an object image for the left eye seen by the left eye of the viewer.

The first imaging device 10 includes a first CCD 15. An imaging lens 11 that is movable in the optical axis direction, an aperture diaphragm 12, an infrared cut filter 13, and an optical low-pass filter 14 are provided on the front side of the first CCD 15. A lens driving circuit (not shown) positions the imaging lens 11 and an aperture diaphragm driving circuit (not shown) controls the opening of the aperture diaphragm 12.

When the imaging mode is set, a light beam indicating an object image is focused by the imaging lens 11 and is then incident on a light receiving surface of the first CCD 15 through the aperture diaphragm 12, the infrared cut filter 13, and the optical low-pass filter 14. The object image is formed on the light receiving surface of the first CCD 15 and a first analog video signal indicating the object image for the right eye is output to the first CCD 15. As such, the first CCD 15 captures the image of the object with a predetermined period and the first video signals indicating each frame of the object images for the right eye are output to the first CCD 15 with a predetermined period.

The second imaging device 20 includes a second CCD 25. An imaging lens 21 that is movable in the optical axis direction, an aperture diaphragm 22, an infrared cut filter 23, and an optical low-pass filter 24 are provided in front of the second CCD 25. The lens driving circuit (not shown) positions the imaging lens 21 and the aperture diaphragm driving circuit (not shown) controls the opening of the aperture diaphragm 22. The second imaging device 20 captures the image of an object at the same time as the first imaging device 10 captures the image, and a second analog video signal indicating an object image for the left eye is output.

The first imaging device 10 and the second imaging device 20 have different disparities and there is a disparity between the object image (first object image) for the right eye captured by the first imaging device and the object image (second object image) for the left eye captured by the second imaging device.

Both the first analog video signal output from the first imaging device 10 and the second analog video signal output from the second imaging device 20 are input to an analog signal processing circuit 31. The analog signal processing circuit 31 includes, for example, a correlated double sampling circuit and a signal amplifying circuit. The analog signal processing circuit 31 performs, for example, a correlated double sampling process and a signal amplifying process on both the first analog video signal output from the first imaging device 10 and the second analog video signal output from the second imaging device 20. The first analog video signal and the second analog video signal output from the analog signal processing circuit 31 are input to an analog/digital conversion circuit 32 and are then converted into first digital image data and second digital image data, respectively. The converted first digital image data and the converted second digital image data are temporarily stored in a main memory 34 under the control of a memory control circuit 33.

The first digital image data and the second digital image data are read from the main memory 34 and then input to a digital signal processing circuit 35. The digital signal processing circuit 35 performs predetermined digital signal processing, such as white balance adjustment and gamma correction. The first digital image data and the second digital image data subjected to digital signal processing by the digital signal processing circuit 35 are input to a display control circuit 40. The display control circuit 40 controls a display device 41 to three-dimensionally display the captured object image on a display screen of the display device 41.

When the shutter release button is pressed in the first stage, the first digital image data and the second digital image data output from the analog/digital conversion circuit 32 are stored in the main memory 34, as described above. The first digital image data read from the main memory 34 is converted into brightness data by the digital signal processing circuit 35. The converted brightness data is input to an integrating circuit 37 and is then integrated. Data indicating the integrated value is given to the CPU 1 and the amount of exposure is calculated. The openings of the aperture diaphragms 12 and 22 and the shutter speeds of the first CCD 15 and the second CCD 25 are controlled to obtain the calculated amount of exposure.

When the shutter release button is pressed in the second stage, similarly, the first image data and the second image data output from the analog/digital conversion circuit 32 are stored in the main memory 34. Similarly, the digital signal processing circuit 35 performs predetermined digital signal processing on the image data read from the main memory 34. The first image data and the second image data output from the digital signal processing circuit 35 are compressed by a compressing/decompressing circuit 36. The compressed first image data and the compressed second image data are stored in a memory card 39 under the control of an external memory control circuit 38.

In this embodiment, it is possible to perform an auto-tracking process on a target image (tracking target) included in the object image. The auto-tracking makes it possible to continuously display a frame (tracking frame) on the tracking target included in the object image (moving picture) that is continuously captured. In addition, the auto-tracking makes it possible to repeatedly capture an image without missing a specific person. In addition, it is possible to adjust the amount of exposure such that the target image has appropriate brightness and adjust focus such that the target image is in focus.

When a tracking target is tracked, it is necessary to set a target image (set an initial target). The digital still camera includes an initial target setting device 42 in order to set the initial position of a tracking frame. The tracking frame set by the initial target setting device 42 is displayed on the display screen of the display device 41. An image (or the image of an object in the vicinity of the tracking frame) in the tracking frame set by the initial target setting device 42 is the target image, and the target image is tracked by an auto-tracking device 43 (tracking target determining unit).

When the reproduction mode is set, the compressed image data stored in the memory card 39 is read. The read compressed image data is decompressed by the compressing/decompressing circuit 36. The decompressed image data is given to the display control circuit 40 and a reproduced image is displayed on the display screen of the display device 41. The auto-tracking process may be performed during reproduction as well as during recording.

A disparity map is used in the auto-tracking process according to this embodiment. A method of generating the disparity map is known and thus will be described briefly.

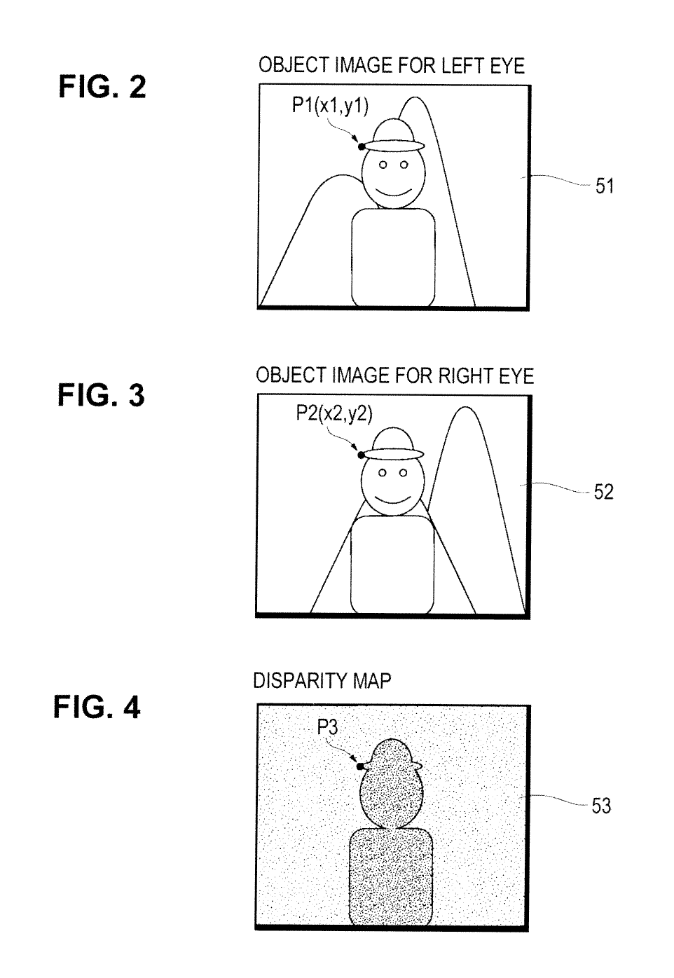

FIGS. 2 to 4 show a method of generating the disparity map.

FIG. 2 shows an example of an object image 51 for the left eye captured by the second imaging device 20. FIG. 3 shows an example of an object image 52 for the right eye captured by the first imaging device 10.

As described above, there is a disparity between the object image 51 for the left eye and the object image 52 for the right eye.

Attention is paid to a specific pixel P1 of the image 51 for the left eye (the pixel P1 of interest). The coordinates of the pixel P1 of interest are (x1, y1). A corresponding pixel P2 corresponding to the pixel P1 of interest of the image 51 for the left eye is detected from the image 52 for the right eye 52. The coordinates of the detected corresponding pixel P2 are (x2, y2). The disparity d between the pixel P1 of interest and the corresponding pixel P2 is as follows: d=x2−x1.

FIG. 4 shows an example of the disparity map.

The disparity map is based on the image 51 for the left eye. However, the disparity map may be based on the image 52 for the right eye. In the disparity map 53, the disparity d (=x2−x1) is stored at a position P3 (x1, y1) corresponding to the pixel P1 of interest of the image 51 for the left eye. In FIG. 4, the disparity map is shown as an image. However, in fact, the disparity map is a set of data. In FIG. 4, a difference in disparity is shown as a difference in grayscale. In FIG. 4, as the grayscale increases, the disparity is reduced.

As described above, pixels corresponding to all pixels of the image 51 for the left eye shown in FIG. 2 are detected from the image 52 for the right eye shown in FIG. 3, and the disparity between the pixels of the image 51 for the left eye and the pixels of the image 52 for the right eye corresponding to all of the pixels of the image 51 for the left eye is calculated. In this way, the disparity map 53 shown in FIG. 4 is generated.

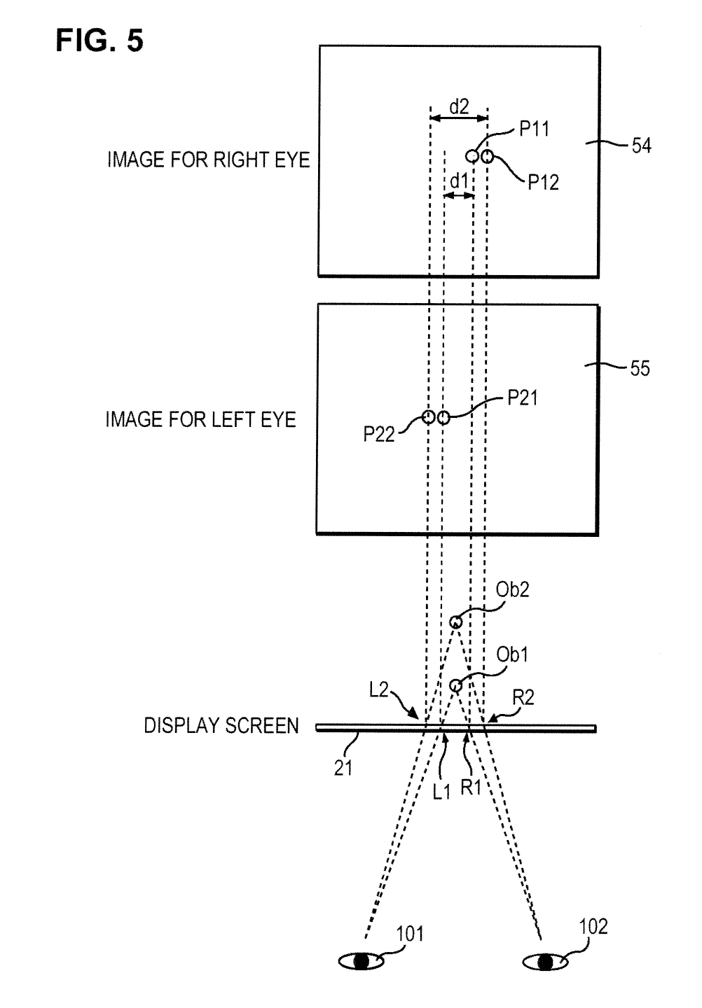

FIG. 5 shows the relationship among the viewing direction of the viewer, an image portion of a three-dimensional image seen by the viewer, an image for the right eye and an image for the left eye of the three-dimensional image, and the disparity.

There is a disparity d1 between an object portion P11 in an image 54 for the right eye and an object portion P21 that is included in the image for the left eye and corresponds to the object portion P11. When the image 54 for the right eye is displayed on a display screen 56, the object portion P11 of the image 54 for the right eye is displayed at a position R1. When the image 55 for the left eye is displayed on the display screen 56, the object portion P21 of the image 55 for the left eye is displayed at a position L1. When the viewer sees the object portion P11 of the image 54 for the right eye displayed at the position R1 with the right eye 58 and sees the object portion P21 of the image 55 for the left eye displayed at the position L1 with the left eye 57, an object portion Ob1 represented as a three-dimensional image by the object portions P11 and P21 is seen at a position that is disposed at a depth L11 from the display screen 56.

There is a disparity d2 between an object portion P12 in the image 54 for the right eye and an object portion P22 that is included in the image for the left eye and corresponds to the object portion P12. When the image 54 for the right eye is displayed on the display screen 56, the object portion P12 of the image 54 for the right eye is displayed at a position R2. When the image 55 for the left eye is displayed on the display screen 56, the object portion P22 of the image 55 for the left eye is displayed at a position L2. When the viewer sees the object portion P12 of the image 54 for the right eye displayed at the position R2 with the right eye 58 and sees the object portion P22 of the image 55 for the left eye displayed at the position L2 with the left eye 57, an object portion Ob2 represented as a three-dimensional image by the object portions P12 and P22 is seen at a position that is disposed at a depth L12 from the display screen 56.

As such, the viewing position (depth) in the three-dimensional image depends on the disparity. Therefore, it is possible to know the relative positional relationship between the objects in the three-dimensional image (the positions of the objects in the depth direction) from the disparity.

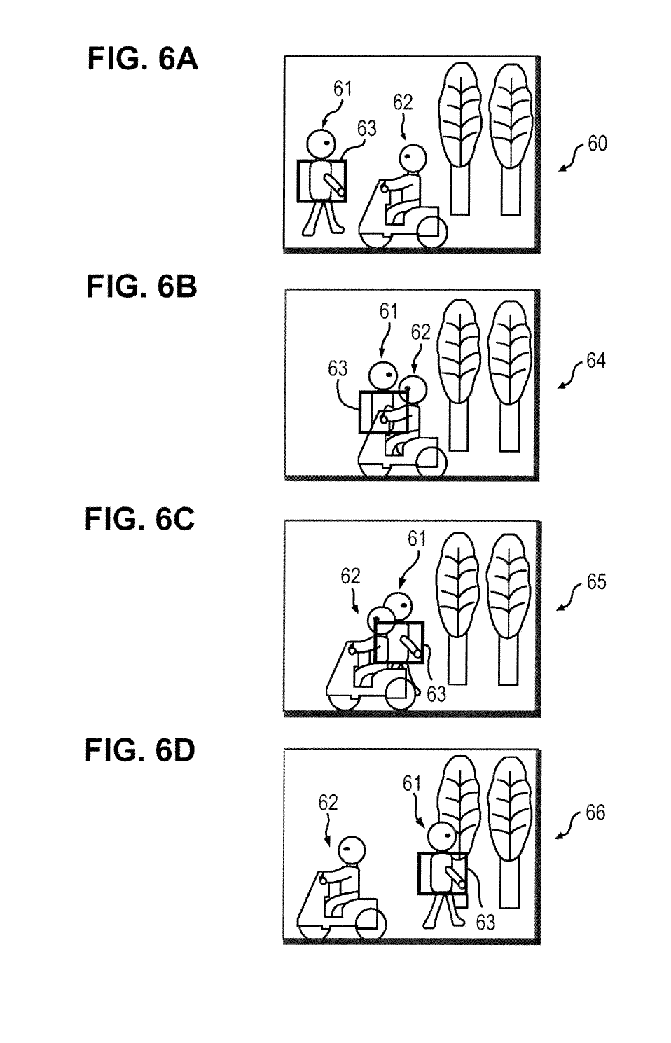

FIGS. 6A to 6D, FIGS. 7A to 7D, and FIGS. 8A to 8D are diagrams illustrating a first auto-tracking method according to this embodiment. In the first method, a portion other than an object disposed between a photographing unit and a tracking target object in the depth direction is set as a tracking target search range.

FIGS. 6A to 6D show captured object images. In this embodiment, as described above, two frames of images, that is, an object image for the left eye and an object image for the right eye are obtained at the same time, and the images are combined into a three-dimensional object image. FIGS. 6A, 6B, 6C, and 6D show three-dimensional object images 60, 64, 65, and 66, respectively. The object images 60, 64, 65, and 66 are captured in this order.

A pedestrian 61 and a bike driver 62 are included in each of the object images 60, 64, 65, and 66. The pedestrian walks from the left side to the right side and the bike is moved from the right side to the left side. The bike moves on the front side of the pedestrian in the depth direction. In these circumstances, as shown in FIG. 6A, the tracking target is set to the pedestrian 61 and the pedestrian 61, which is a tracking target, is detected by auto-tracking. In this way, a tracking frame 63 is displayed on the pedestrian 61.

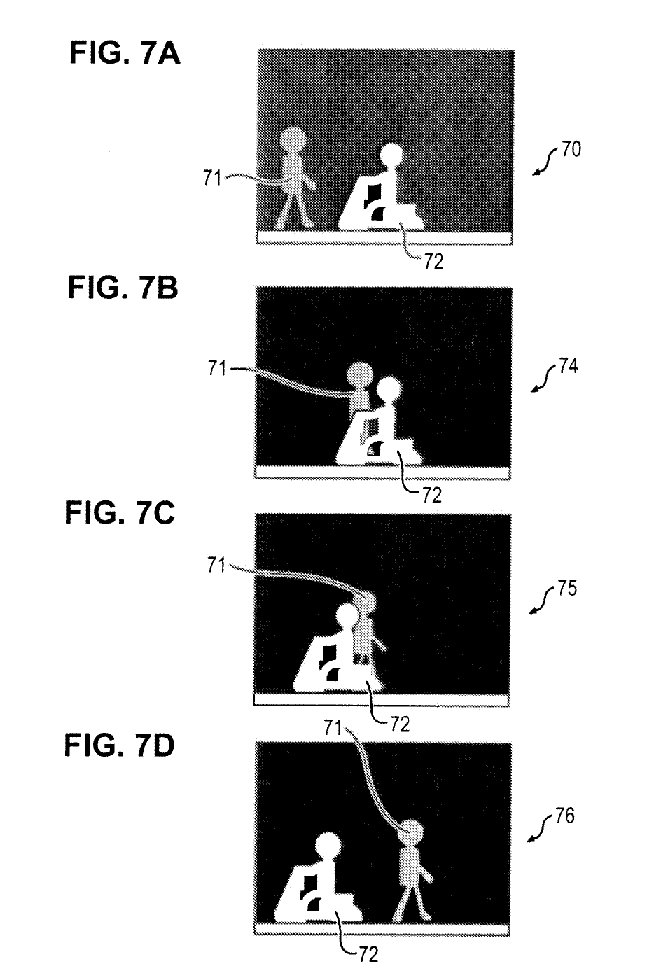

FIGS. 7A, 7B, 7C, and 7D show disparity map images 70, 74, 75, and 76, which are the images of the disparity maps, respectively corresponding to the object images 60, 64, 65, and 66 shown in FIGS. 6A, 6B, 6C, and 6D. In the disparity map images 70, 74, 75, and 76, as an object is closer to the front side in the depth direction, the brightness of the object is increased, and as an object is closer to the rear side in the depth direction, the brightness of the object is decreased. A bright portion is shown in white and a dark portion is shown in black. However, the bright portion may be shown in black and the dark portion may be shown in white. As described above, since the disparity depends on the relative distance between the objects, it is understood that the disparity map images 70, 74, 75, and 76 indicate the distance to the object. The disparity map images 70, 74, 75, and 76 may be represented by grayscale, not brightness. As an object is closer to the front side in the depth direction, the grayscale of the image of the object is decreased, and as an object is closer to the rear side in the depth direction, the grayscale of the image of the object is increased. Conversely, as an object is closer to the front side in the depth direction, the grayscale of the image of the object may be increased, and as an object is closer to the rear side in the depth direction, the grayscale of the image of the object may be decreased.

In FIGS. 7A to 7D, a gray image portion 71 corresponds to the pedestrian 61 and a white image portion 72 corresponds to the bike driver 62. As shown in FIGS. 7A to 7D, the bike driver 62 is disposed on the front side of the pedestrian 61 in the depth direction.

In the first method, as described above, a portion other than the object which is disposed between the photographing unit and the tracking target object in the depth direction is set to the tracking target search range. Specifically, in FIGS. 7A to 7D, an image portion whiter than the gray image portion 71 corresponding to the pedestrian 61, which is a tracking target, is disposed on the front side of the pedestrian 61 in the depth direction. Therefore, the white image portion is excluded from the search range.

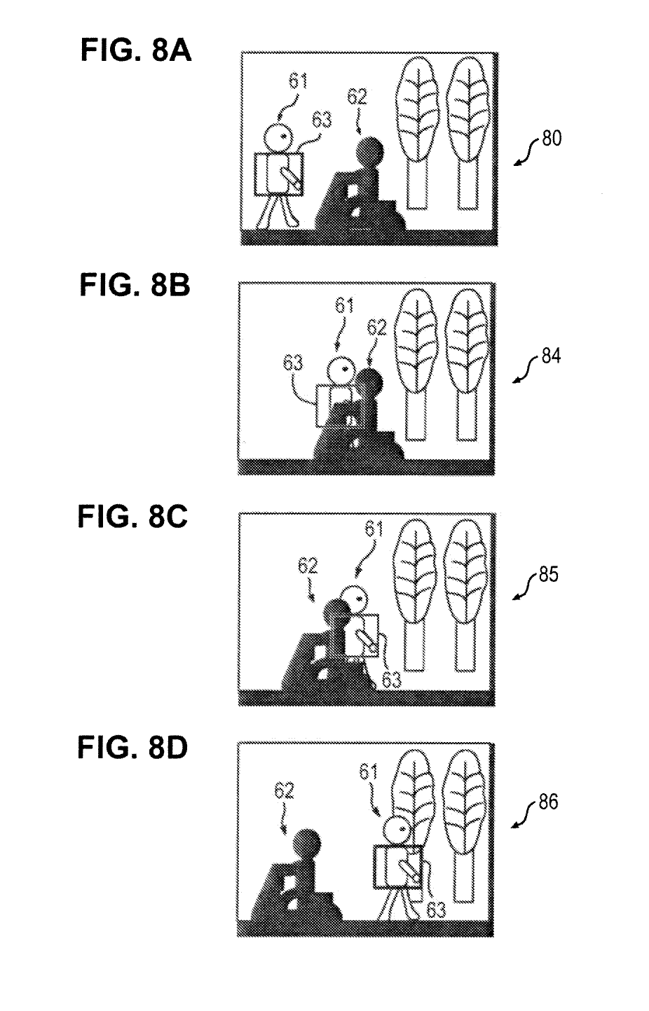

FIGS. 8A to 8D show an example of an object image in which a black portion is excluded from the search range (a white portion is excluded from the search range in FIGS. 7A to 7D, but a black portion is excluded from the search range in FIGS. 8A to 8D for ease of understanding).

In object images 80, 84, 85, and 86 respectively corresponding to the object images 60, 64, 65, and 66, a portion other than a black image portion is the tracking target search range. In each of the object images 80, 84, 85, and 86, a set tracking target portion 63 is detected from the pedestrian 61, which is a tracking target. As shown in FIG. 6B or 6C, when a portion disposed on the front side of the pedestrian 61, which is a tracking target, in the depth direction is not excluded from the search range and another object (bike driver 62) is disposed on the front side of the pedestrian 61, which is a tracking target, in the depth direction, the pedestrian 61 is not tracked, but the object disposed between the photographing unit and the tracking target in the depth direction is tracked. However, according to this method, it is possible to prevent an object disposed between the photographing unit and the tracking target in the depth direction from being tracked.

In the above-mentioned method, the object disposed between the photographing unit and the tracking target in the depth direction is excluded from the search range of the tracking target. However, since the distance to the object depends on the disparity between the objects, a portion other than an object (image portion) with a disparity less than that of the tracking target may be determined to be a tracking target detection range.

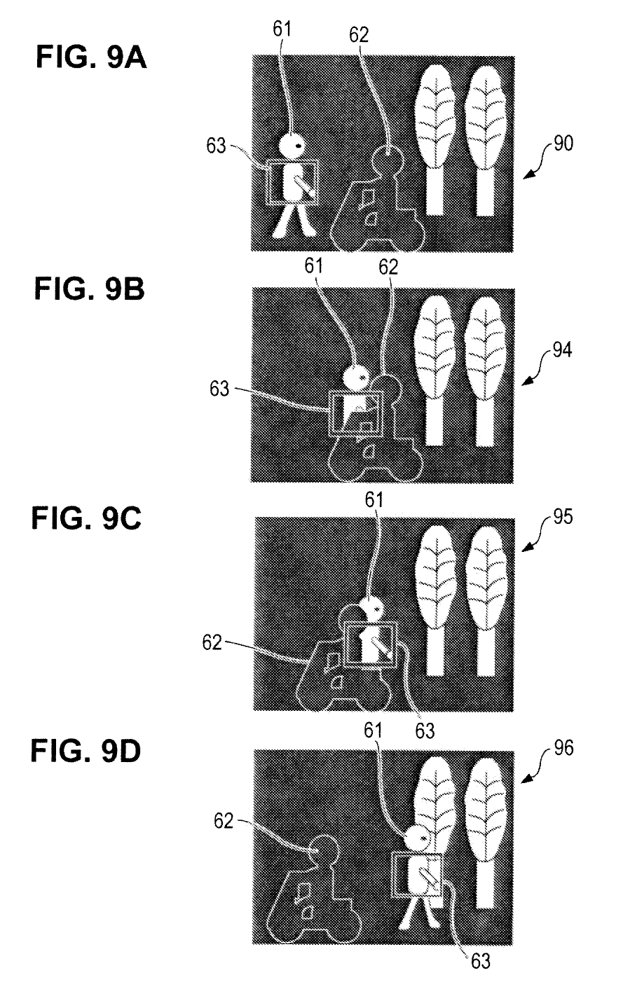

FIGS. 9A to 9D are diagrams illustrating a second auto-tracking method and show an example of the object image.

The object images 90, 94, 95, and 96 correspond to the object images 60, 64, 65, and 66. In the object images 90, 94, 95, and 96, a portion of the object with a disparity beyond a predetermined range of the disparity of the pedestrian 61 (an object in the tracking frame 63), which is a tracking target, is shown in black. In the second method, a portion with a disparity within a predetermined range of the disparity of the tracking target is a tracking target detection range. In FIGS. 9A to 9D, a portion other than a black portion is the tracking target detection range. In the second method, an object disposed in the vicinity of the front side or the rear side of the tracking target is limited to the tracking target detection range. It is possible to prevent an object other than the tracking target from being tracked.

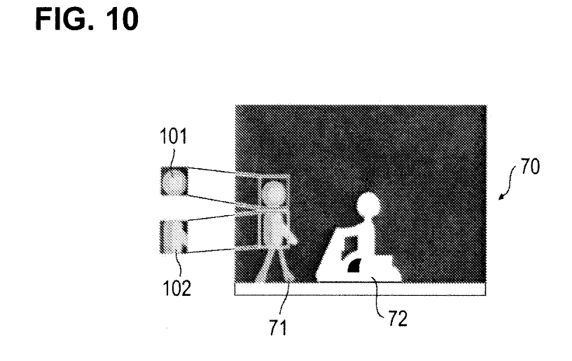

FIG. 10 is a diagram illustrating a third auto-tracking method.

FIG. 10 shows the disparity map image 70 (FIG. 7A). Template images 101 and 102 are extracted from the gray portion 71 corresponding to the pedestrian 61, which is a tracking target. One or three or more template images may be extracted. The extracted template images 101 and 102 are detected from a disparity map image 74 that is generated after the disparity map image 70 from which the template images 101 and 102 are extracted. The positions of the template images 101 and 102 detected from the disparity map image 74 are the position of the pedestrian 61, which is a tracking target, in the object image 64 corresponding to the disparity map image 74. In this way, it is possible to track a low-contrast object image that is hardly detected by brightness or color difference.

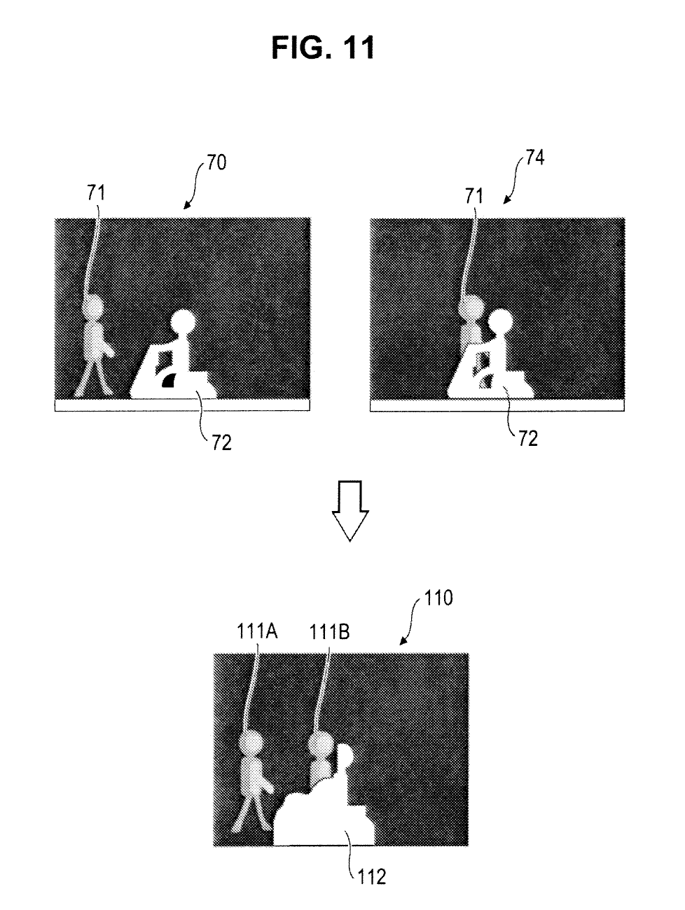

FIG. 11 is a diagram illustrating a fourth auto-tracking method. In the fourth method, a differential disparity map image between two disparity map images is generated.

A differential disparity map image 110 indicating the difference between the disparities of the first disparity map image 70 and the second disparity map image 74 is generated from the first disparity map image 70 and the second disparity map image 74. The differential disparity map image 110 is generated by subtracting (calculating the absolute value) the disparities of all pixel positions in the object image 60 corresponding to the first disparity map image 70, which are disparities corresponding to all pixel positions in the object image 64 corresponding to the second disparity map image 74, from the disparities of all pixel positions in the object image 64 corresponding to the second disparity map image 74.

The differential disparity map image 110 is divided into a moving object portion and a non-moving object portion. For example, in the differential disparity map image 110, gray image portions 111A and 111B correspond to the pedestrian 61 who walks from the left side to the right side, and a white portion 112 corresponds to the bike driver 62 who moves from the right side to the left side. Image portions corresponding to the template images 101 and 102 are detected from the gray portions 111A and 111B and the white portion 112. In this way, auto-tracking is performed.

In the above-described embodiment, for ease of understanding, the disparity map is made into an image. However, the disparity map is not necessarily made into an image except for the method shown in FIG. 9. Any methods capable of determining the disparity (distance) may be used.

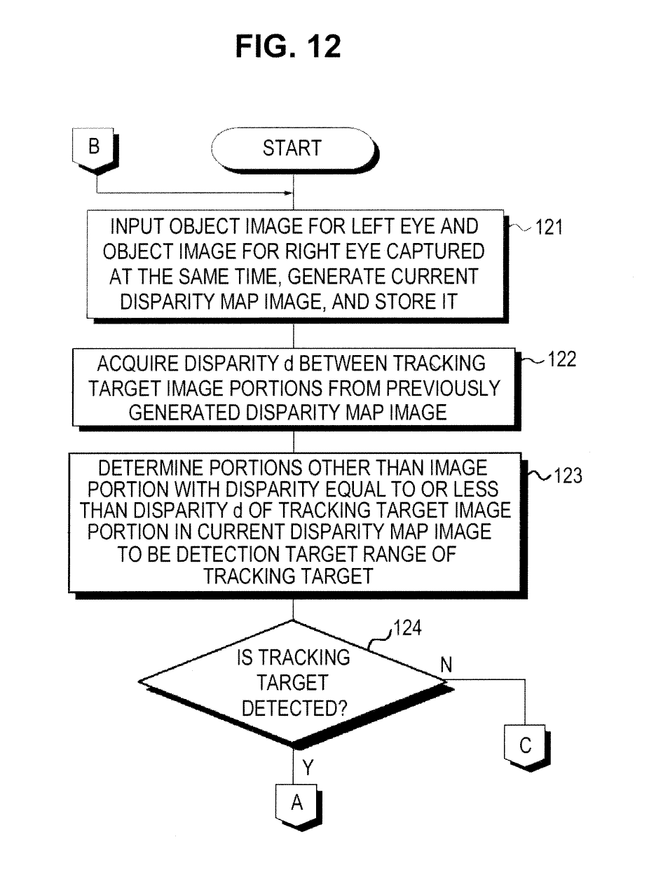

FIGS. 12 to 15 are flowcharts illustrating an auto-tracking process. In the process, it is assumed that the object image 60 shown in FIG. 6A is obtained and the pedestrian 61, which is a tracking target, is designated from the object image 60. For example, a touch panel is formed on the display screen on which the object image 60 is displayed, and the user touches the image of the pedestrian 61 to designate the pedestrian 61, which is a tracking target.

The object image for the left eye and the object image for the right eye that are captured at the same time are input to generate the current disparity map image at that time, and the generated current disparity map image is stored (Step 121 of FIG. 12). For example, when the object image 64 shown in FIG. 6B is obtained by the object image for the left eye and the object image for the right eye, the disparity map image 74 shown in FIG. 7B is generated.

The disparity d of a tracking target image portion is obtained from the previously generated disparity map image 70 (Step 122 of FIG. 12).

First, the auto-tracking process is performed by the first method. That is, a portion (as described above, an image portion of the object disposed on the front side of the pedestrian 61, which is a tracking target, in the depth direction may be excluded) other than the image portion with a disparity less than the disparity d of the tracking target image portion in the current disparity map image 74 is determined as the detection target range of a tracking target. In the disparity map image 74 shown in FIG. 7B, a portion other than the white portion 72 is the detection target range. In the object image 84 shown in FIG. 8B, a portion other than a black portion is the detection target range. An auto-tracking process of detecting the pedestrian 61 designated as a tracking target in the determined detection target range from the object image 64 is performed.

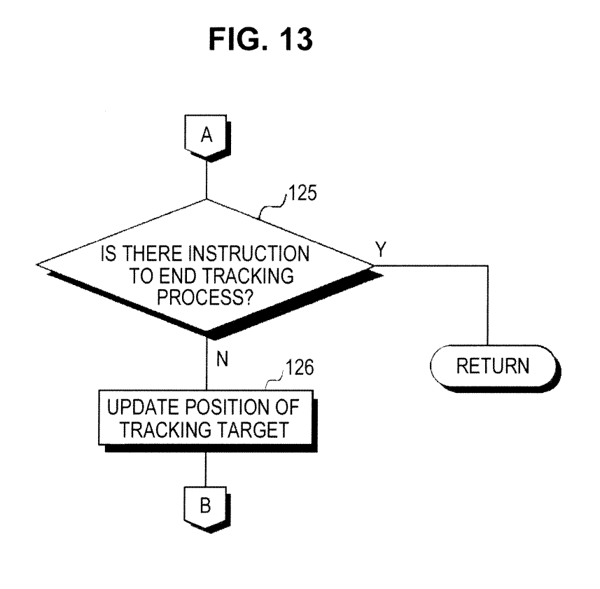

When the tracking target is detected (YES in Step 124 of FIG. 12) and there is no instruction to end the tracking process (NO in Step 125 of FIG. 13), the tracking target position of the detected pedestrian 61 is updated (Step 126 of FIG. 13).

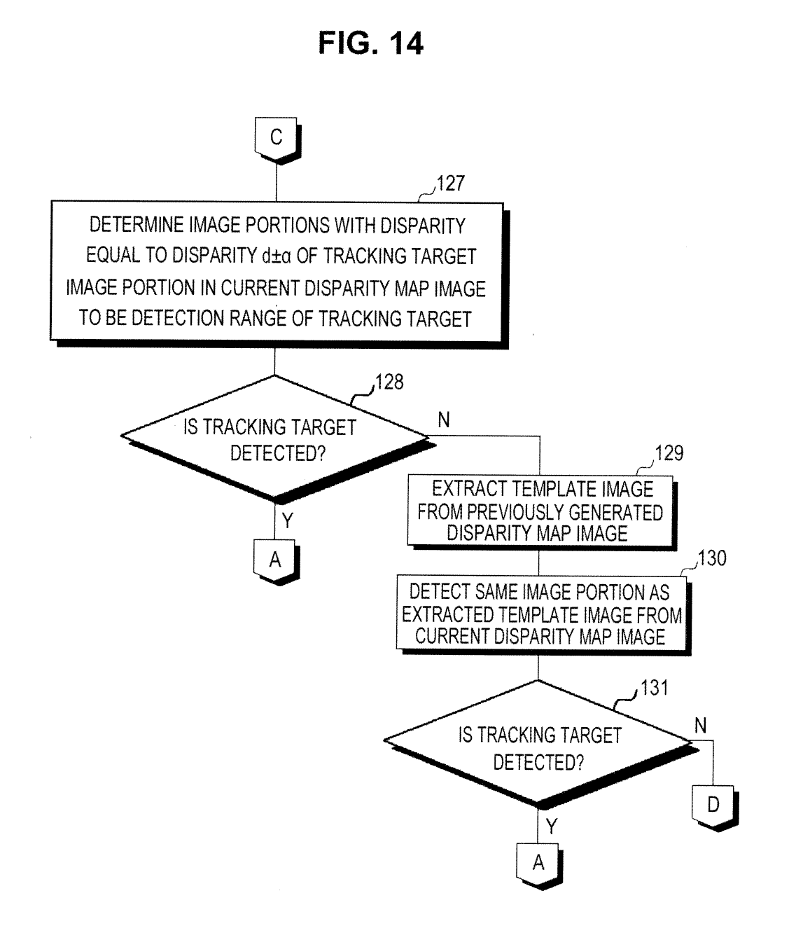

When the tracking target is not detected (NO in Step 124 of FIG. 12), the auto-tracking process is performed by the second method. That is, in the current disparity map image 74, an image portion with a disparity equal to the disparity d±α (α is a predetermined value) of the tracking target portion is determined as the tracking target detection range (Step 127 of FIG. 14). In the object image 94 shown in FIG. 9B, a portion other than a black portion is the detection target range. As shown in FIG. 9B, the pedestrian 61, which is a tracking target, is detected in the determined detection target range. When the tracking target is detected (YES in Step 128 of FIG. 14) and there is no instruction to end the tracking process (NO in Step 125 of FIG. 13), the tracking target position of the detected pedestrian 61 is updated (Step 126 of FIG. 13).

When the tracking target is not detected (NO in Step 128 of FIG. 14), the auto-tracking process is performed by the third method. First, the template images 101 and 102 corresponding to the pedestrian, which is a tracking target, are extracted from the previously generated disparity map image 70 (Step 129 of FIG. 14). The same image portions as the extracted template images 101 and 102 are detected from the current disparity map image 74 (Step 130 of FIG. 14). When the tracking target is detected (YES in Step 131 of FIG. 14) and there is no instruction to end the tracking process (NO in Step 125 of FIG. 13), the tracking target position of the detected pedestrian 61 is updated (Step 126 of FIG. 13).

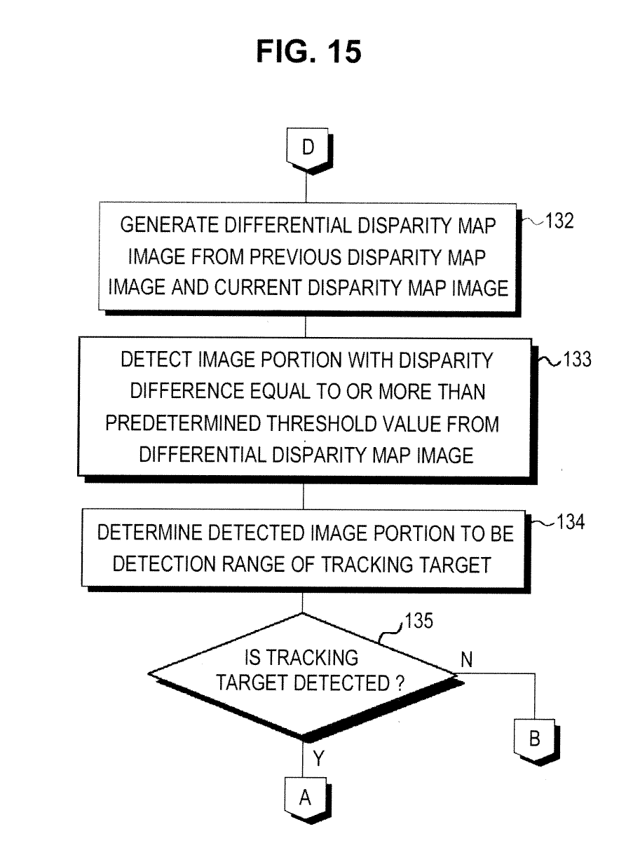

When the tracking target is not detected (NO in Step 131 of FIG. 14), the auto-tracking process is performed by the fourth method. That is, the differential disparity map image 110 is generated from the previous disparity map image 70 and the current disparity map image 74 (Step 132 of FIG. 15). An image portion with a disparity difference equal to or more than a predetermined threshold value is detected from the generated differential disparity map image 110 (Step 133 of FIG. 15). The detected image portion is determined as the tracking target detection range (Step 134 of FIG. 15). When the tracking target is detected (YES in Step 135 of FIG. 15) and there is no instruction to end the tracking process (NO in Step 125 of FIG. 13), the tracking target position of the detected pedestrian 61 is updated (Step 126 of FIG. 13).

When the tracking target is not detected (NO in Step 135 of FIG. 15), the tracking target position is not updated and the tracking process is repeated from Step 121 of FIG. 12.

Then, similarly, the auto-tracking process is repeatedly performed on the image for the left eye and the image for the right eye that are sequentially input. In this way, as shown in FIGS. 6A to 6D, a mark 63 is continuously displayed on the pedestrian 61, which is a tracking target.

In the above-described embodiment, the first to fourth methods are combined to perform the auto-tracking process. However, the first to fourth methods may be individually performed or any combination of the first to fourth methods may be performed. Moreover, two taking lenses are used to obtain the first object image data and the second object image data in the above-described embodiment. However, the present invention is not limited to such configuration, and for example, more than three taking lenses may be equipped and any combination of two taking lenses out of more than three taking lenses may be used to obtain the first object image data and the second object image data. In particular, for example, by aligning plurality of lenses, even though the object has been moved to be excluded from the flames of two taking lenses which had started photographing in the first place, the object excluded from flames of two lenses can sequentially be included in the adjacent flames of two lenses. With such configuration, object moving over wide area can be tracked without moving the camera.

What is claimed is:

1. An object tracking device to which a first object image data indicating a first object image captured by a photographing unit and a second object image data that has a disparity with respect to the first object image and indicates a second object image captured by the photographing unit at the same time as the first object image is captured are continuously input, comprising:
a tracking target determining unit that determines a tracking target object;
a disparity map generating unit that generates a disparity map indicating the disparity between portions of the first object image and the second object image respectively indicated by the first object image data and the second object image data which are obtained by image capture at the same time and are continuously input;
a detection target range determining unit that determines a portion other than an object which is disposed between the photographing unit and the tracking target object determined by the tracking target determining unit in the depth direction to be a detection target range of the tracking target, on the basis of the disparity map generated by the disparity map generating unit; and
a tracking object image detecting unit that detects an object image indicating the tracking target object from at least one of the first object image and the second object image in the detection target range determined by the detection target range determining unit.

2. The object tracking device according to claim 1,
wherein the detection target range determining unit determines a portion other than an image portion with a disparity less than that of an image portion corresponding to the tracking target object to be the tracking target detection range, on the basis of the disparity map generated by the disparity map generating unit.

3. The object tracking device according to claim 1,
wherein the detection target range determining unit determines an image portion with a disparity within a predetermined disparity range of an image portion corresponding to the tracking target object to be the tracking target detection range, on the basis of the disparity map generated by the disparity map generating unit.

4. An object tracking device to which a first object image data indicating a first object image and a second object image data that has a disparity with respect to the first object image and indicates a second object image captured at the same time as the first object image is captured are continuously input, comprising:
a tracking target determining unit that determines a tracking target object;
a disparity map image generating unit that generates a disparity map image whose brightness or grayscale varies depending on the disparity between portions of the first object image and the second object image respectively indicated by the first object image data and the second object image data which are obtained by image capture at the same time and are continuously input;
a template image extracting unit that extracts an image portion corresponding to the tracking target object determined by the tracking target determining unit as a template image in the disparity map image generated by the disparity map image generating unit; and
a tracking object image detecting unit that detects the same image portion as the template image extracted by the template image extracting unit from a disparity map image which is generated by the disparity map image generating unit after the disparity map image from which the template image is extracted by the template image extracting unit.

5. An object tracking device to which a first object image data indicating a first object image and a second object image data that has a disparity with respect to the first object image and indicates a second object image captured at the same time as the first object image is captured are continuously input, comprising:
a tracking target determining unit that determines a tracking target object;
a disparity map generating unit that generates a disparity map indicating the disparity between portions of the first object image and the second object image respectively indicated by the first object image data and the second object image data which are obtained by image capture at the same time and are continuously input;
a differential disparity map generating unit that generates a differential disparity map indicating a difference between the disparities of two disparity maps generated by the disparity map generating unit; and
a tracking object image detecting unit that detects an object image indicating the tracking target object determined by the tracking target determining unit from the first object image or the second object image corresponding to a portion with a disparity difference equal to or more than a predetermined value in the differential disparity map generated by the differential disparity map generating unit.

6. A method of controlling the operation of an object tracking device to which a first object image captured by a photographing unit data indicating a first object image and a second object image data that has a disparity with respect to the first object image and indicates a second object image captured by a photographing unit at the same time as the first object image is captured are continuously input, the method comprising:
allowing a tracking target determining unit to determine a tracking target object;
allowing a disparity map generating unit to generate a disparity map indicating the disparity between portions of the first object image and the second object image respectively indicated by the first object image data and the second object image data which are obtained by image capture at the same time and are continuously input;
allowing a detection target range determining unit to determine a portion other than an object which is disposed between the photographing unit and the tracking target object determined by the tracking target determining unit in the depth direction to be a detection target range of the tracking target, on the basis of the disparity map generated by the disparity map generating unit; and
allowing a tracking object image detecting unit to detect an object image indicating the tracking target object from at least one of the first object image and the second object image in the detection target range determined by the detection target range determining unit.

7. A method of controlling the operation of an object tracking device to which first object image data indicating a first object image and second object image data that has a disparity with respect to the first object image and indicates a second object image captured at the same time as the first object image is captured are continuously input, the method comprising:
allowing a tracking target determining unit to determine a tracking target object;
allowing a disparity map image generating unit to generate a disparity map image whose brightness or grayscale varies depending on the disparity between portions of the first object image and the second object image respectively indicated by the first object image data and the second object image data which are obtained by image capture at the same time and are continuously input;
allowing a template image extracting unit to extract an image portion corresponding to the tracking target object as a template image in the disparity map image generated by the disparity map image generating unit; and
allowing a tracking object image detecting unit to detect the same image portion as the template image extracted by the template image extracting unit from a disparity map image which is generated by the disparity map image generating unit after the disparity map image from which the template image is extracted by the template image extracting unit.

8. A method of controlling the operation of an object tracking device to which first object image data indicating a first object image and second object image data that has a disparity with respect to the first object image and indicates a second object image captured at the same time as the first object image is captured are continuously input, the method comprising:
allowing a tracking target determining unit to determine a tracking target object;
allowing a disparity map generating unit to generate a disparity map indicating the disparity between portions of the first object image and the second object image respectively indicated by the first object image data and the second object image data which are obtained by image capture at the same time and are continuously input;
allowing a differential disparity map generating unit to generate a differential disparity map indicating a difference between the disparities of two disparity maps generated by the disparity map generating unit; and
allowing a tracking object image detecting unit to detect an object image indicating the tracking target object determined by the tracking target determining unit from the first object image or the second object image corresponding to a portion with a disparity difference equal to or more than a predetermined value in the differential disparity map generated by the differential disparity map generating unit.
